(19) United States
(12) Patent Application Publication
(10) Pub. No.: US 2019/0340919 A1
(43) Pub. Date: Nov. 7, 2019

(54) BACK COVER FOR PORTABLE TERMINAL HAVING REMOTE CONTROL FUNCTION MOUNTED THEREON AND METHOD FOR CONTROLLING ELECTRONIC PRODUCT USING SAME

(71) Applicant: LANTIS CO., LTD., Busan (KR)

(72) Inventor: Yong Hoon KIM, Busan (KR)

(21) Appl. No.: 16/468,762

(22) PCT Filed: Dec. 13, 2016
(86) PCT No.: PCT/KR2016/014572

§ 371 Date: Jul. 17, 2019

(51) Int. Cl. G08C 23/04; H04M 1/02; H04Q 9/00; H04L 29/08; A45C 11/00

(52) U.S. Cl. CPC G08C 23/04; H04M 1/026; H04Q 9/00; G08C 2201/91; A45C 11/00; A45C 2011/002; H04L 29/08

(57) ABSTRACT

Provided is a back cover for a portable terminal having remote control function, comprising: an infrared module provided on an upper end of the back cover, receiving power from the portable terminal, and emitting infrared rays; a button module including function keys, provided on a front surface of the back cover, and transmitting a control signal to the infrared module, wherein the control signal remotely controls an electronic product; a power supply and data connection module provided on a lower end of a back surface of the back cover; an application execution function key provided on the back cover and executing a remote control application which is installed on the portable terminal; and a camera activation function key provided on the back cover and activating a camera, wherein the camera is mounted on the portable terminal.

### TECHNICAL FIELD

The present invention relates to a back cover for a portable terminal and a method of controlling an electronic product using the back cover. The back cover has a remote control function. A portable terminal such as a smartphone has a display unit and a back cover. The display unit is provided on a front surface of the portable terminal. The back cover is provided on a back surface of the portable terminal.

The back cover is provided with function keys, which remotely control electronic products. The back cover is inked with a remote control application which is installed on the portable terminal. Various electronic products can be pre-registered or pre-stored on the portable terminal. Remote control functions corresponding to the respective electronic products can be automatically searchable using location information of the respective electronic products.

### TECHNICAL BACKGROUND

Various applications are known for use in smart phones. One of them is a remote control application for TV. Respective button signals for respective remote controls are generated on the smart phone and emitted through a separate infrared module. Respective control signals are pre-assigned to respective buttons. When a given button is selected on a touch screen, a control signal corresponding to the given button is emitted out. Such application is convenient in that, even when a remote controller is lost, a user still can execute a remotely control by using the application for smart phones.

However, a user must have to locate proper applications, have to install the applications separately, and have to manipulate the smartphones to execute the applications. Furthermore, when the screen is turned off due to a screen brightness control, it is necessary to turn on the screen again to execute the remote control applications. In addition, when a call comes in or a text message or an SNS message is received while the remote control application is running, the remote control application enters a standby mode and is pushed into a background mode.

Put it in another way, using the remote control applications on a conventional smartphones is inconvenient. Smartphone has so many functions and frequency of use. So, to activate a specific application, a user has to do multiple touches and manipulations. For user convenience, it is required for a use to activate the remote control applications by a simple manipulation, e.g., pressing a given button.

For example, when a user wants to control a volume, he or she may run a remote control application and press a button assigned for the volume up/down control. After then, when the user wants to change a channel, he or she needs to turn on the smartphone again, pull up the remote control application running in the background mode, and manipulate the remote control application to change the channel. Such manipulation is a hassle for a user compared to its simple function. For this reason, remote control applications are not widely used.

Meanwhile, in order to prevent scratches or damage to the smartphones, various types of cases are used. Recently, wallet-type smartphone cases are widely used. The wallet-type smartphone case is configured so that the smartphone is fixed on the back side of the case. The front side of the smartphone case covers the front side of the smartphone in an openable and closable manner. When the smartphone is covered with the wallet-type smartphone case, the user has to do additional action of opening and closing the front cover of the wallet-type smartphone case in advance of manipulating the remote control application. Such action imposes an additional inconvenience.

On the other hand, the conventional wallet-type smartphone case merely serves as a substitute of a wallet for carrying credit cards and provides no additional use except it. However, when the above-described remote control function is implemented on a smartphone case, it may be a more convenient and user-oriented device.

An example of such device is disclosed in Korean Patent. No. 10-1358681, which is entitled “a wallet-type smartphone case having a remote control function” filed on Mar. 5, 2013 and registered on Jan. 28, 2014. The Korean Patent discloses, in the background of the invention section, a wallet-type smartphone case controlling TV using a button module provided on a front face of a wallet-type smartphone case and an infrared module mounted on an earphone hole of the smartphone. This device is convenient in that a user can remotely control TV without executing any remote control application.

FIG. 1 is a block diagram showing a conventional wallet-type smartphone case having a remote control function. The conventional wallet-type smartphone case, which has a remote control function and disclosed in the above-mentioned patent document, includes: a terminal for plugging into an earphone hole of a smartphone; an infrared module that receives power from the smartphone through the terminal and emits infrared rays; a button module provided on the wallet-type smartphone case and transmitting a signal when a button is pressed by a user; and a cable connected between the infrared module and the button module, supplying power from the smartphone to the button module, and transmitting the signal from the button module to the infrared module.

As described above, main components of the conventional wallet-type smartphone case disclosed in the above patent document includes: an infrared module, a button module, and a cable. TV is remotely controlled using the button module provided on the front surface and the infrared module mounted in the earphone hole. This device is convenient in that a user can remotely control TV without executing any separate remote control application.

However, the above-mentioned conventional art has the following problems. First, this technology is merely applies an existing remote control function into a smartphone case with no interworking between the smartphone case and the smartphone capable of wireless communication. That is, there is nothing more than that a remote control function is mounted on a smartphone case.

Second, the conventional wallet-type smartphone case is inconvenient to use in that the infrared module, which transmits a predetermined infrared ray to control an electronic product, is connected to the smartphone case through a cable. Moreover, the infrared module is required to be stored/carried in a holder provided on an inner connecting surface of the case when the remote control function is not in use. This causes additional inconvenience.

Third, various types of electronic products may be located in different places such as home or office. It is difficult to control individual remote control of various electronic products in different places.

### DETAILED DESCRIPTION OF THE INVENTION

### Problems to be Solved

An objective of the present invention to solve such problems. Proposed is a smartphone back cover which has remote control function, is capable of interworking with an application installed on a portable terminal such as a smartphone, and is capable of performing independent remote control function.

### Solution to Solve the Problem

According to an embodiment of the present invention, a back cover for a portable terminal having a remote control function includes: an infrared module provided on an upper end of the back cover, receiving power from the portable terminal, and emitting infrared rays; a button module including function keys, provided on a front surface of the back cover, and transmitting a control signal to the infrared module, wherein the control signal remotely controls an electronic product; a power supply and data connection module provided on a lower end of a back surface of the back cover; an application execution function key executing a remote control application which is installed on the portable terminal; and a camera activation function key provided on the back cover and activating a camera, wherein the camera is mounted on the portable terminal.

The back cover further includes a power function key. When the power function key is turned on, the remote control application activates the remote control application. The remote control application receives GPS information from a position sensor of the portable terminal and controls through the button module the electronic product within a predetermined distance from the GPS information.

In one embodiment of the present invention, when the application execution function key is executed, a function control unit is displayed on a display unit of the portable terminal. The electronic product is controlled using the function control unit. According to another embodiment of the present invention, a method for controlling an electronic product using a back cover is provided. The back cover is provided on a portable terminal and has a remote control function.

The back cover includes: an infrared module provided on an upper end of the back cover, receiving power from the portable terminal, and emitting infrared rays; a button module including function keys, provided on a front surface of the back cover, and transmitting a control signal to the infrared module, wherein the control signal remotely controls an electronic product; a power supply and data connection module provided on a lower end of a back surface of the back cover; an application execution function key executing a remote control application which is installed on the portable terminal; a camera activation function key provided on the back cover and activating a camera, wherein the camera is mounted on the portable terminal; and a power function key provided on a front surface of the back cover.

The method includes: turning on the power function key; selecting the application execution key module; activating the remote control application installed on the portable terminal; extracting a second GPS information which matches a first GPS information and is within a predetermined distance from the first GPS information, wherein the first GPS information is related to a first location where the remote control application is activated, wherein the second GPS information is related to a second location pre-stored on the remote control application; linking the control signal with a first function key of the button module through the power and data connection module, wherein the control signal controls the electronic product corresponding to the second GPS information extracted; and when the first function key is selected from the button module, transmitting the control signal through the infrared module and remotely controlling the electronic product.

### Advantages of Invention

A back cover for a portable terminal having the remote control function according to the present invention is advantageous in the following aspects. An electronic product is controlled by a back cover for a portable terminal having the remote control function according to the present invention as follows.

Electronic products at different places are individually registered. At a given place where a given electronic device is located, the user selects a power function key and activates an application execution function key. Then, a given signal is transmitted from a control unit of the portable terminal. The given signal is assigned to control the given electronic device at the given place. The given signal is transmitted through the power module and the data connection module to the infrared module. Thus, the present invention is advantageous in that the electronic products can be remotely controlled using the portable terminal anywhere.

### BRIEF DESCRIPTION OF DRAWINGS

FIG. 1 is a block diagram shows a conventional wallet-type smartphone case having a remote control function.

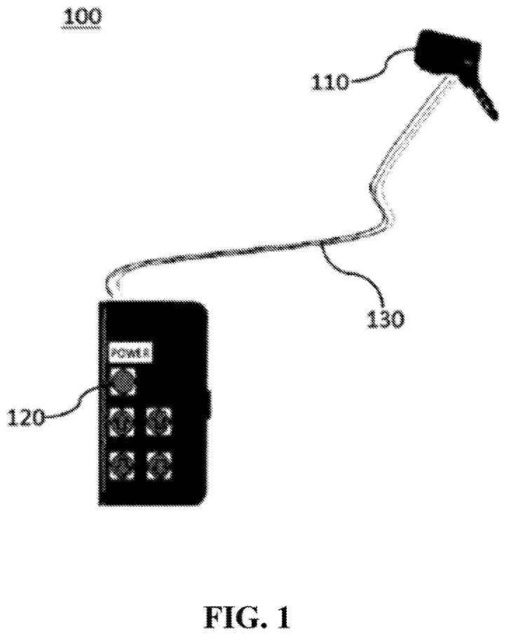

FIG. 2 is a back cover for a portable terminal having a remote control function according to an embodiment of the present invention.

FIG. 3 is a flowchart illustrating a method for controlling an electronic product using a back cover for a portable terminal according to an embodiment of the present invention. The back cover has a remote control function.

### EMBODIMENTS

Hereinafter, a back cover for a portable terminal, which has a remote control function, according to the present invention and a method fur controlling an electronic product using the same will be described with reference to the drawings.

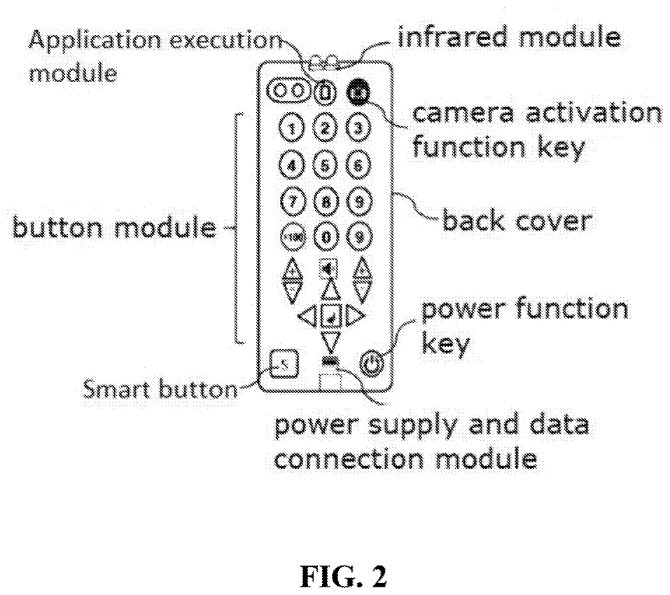

FIG. 2 shows a back cover for a portable terminal, which has a remote control function, according to an embodiment of the present invention. The portable terminal according to the present invention includes all kinds of portable terminals such as a smartphone, a tablet, and the like. The portable terminal includes a display unit and a back cover. The display unit is provided on a front side of the portable terminal. The back cover is provided on a back side of the portable terminal and covers a battery etc. According to the present invention, remote control function is embodied on the back cover.

Hereinafter, the following components are provided on a back cover for a portable terminal will be described. The following components are electrically connected on a back side (not shown) of the back cover. Description on the back side of the back cover will be omitted.

As shown in FIG. 2, a back cover for a portable terminal according to an embodiment of the present invention has a remote control function and includes: an infrared module provided on an upper end of the back cover, receiving power from the portable terminal, and emitting infrared rays; a button module including function keys, provided on a front surface of the back cover, and transmitting a control signal to the infrared module, wherein the control signal remotely controls an electronic product; a power supply and data connection module provided on a lower end of a back surface of the back cover; an application execution function key executing a remote control application which is installed on the portable terminal; a camera activation function key provided on the back cover and activating a camera, wherein the camera is mounted on the portable terminal; and a power function key.

In the present invention, the infrared module transmits a predetermined infrared signal for controlling operation of a predetermined electronic product. The button module according to the present invention may include function keys mounted on a conventional remote controller and may include at least a numeric function key for channel selection, a function key for volume control, a function key for changing channels, and the like.

The power supply and data connection module of the present invention is connected to a main body of the mobile terminal, receives power from the portable terminal, and receives data information of an application which is activated on the portable terminal. An application execution function key, a camera activation function key provided on the back cover and activating a camera installed in the portable terminal, and a power function key are further provided.

In the present invention, except for the infrared module and the power and data connection module, other components such as the button module, the application execution function key, the camera activation function key, and the power function key may be made with rubber buttons or the like.

Hereinafter, a method for controlling an electronic product using the back cover for the portable terminal according to the present invention will be described. The back cover has a remote control function. According to the present invention, remote control function keys etc. and a remote control application are linked with each other.

The remote control function keys etc. are provided on the back cover of the portable terminal and remotely controls electronic products. The remote control application is installed on the portable terminal. Remote control functions corresponding to respective electronic products are automatically searched. Hereinafter, a step of registering electronic products on an application and a step of using it after registration will be described.

[Pre-Registration of Electronic Products for Remote Control Operation]

First, the power function key on the back cover of the present invention is tamed on. When the power function key is selected, power is supplied to modules and function keys formed on the back cover through the power and data connection module.

Next, when the application execution function key is selected, the information of the application execution function key is transmitted to the control unit of the portable terminal through the power and data connection module. The control unit activates the remote control application. The remote control application is displayed on the display unit of the portable terminal. The activated remote control application stores GPS information through a position sensor of the portable terminal.

Finally, electronic products in a given place (home, office, etc.) are registered using the remote control application. For reference, there are many ways to register electronic products using an application. Thus, any conventional method can be selected for implementing the present invention.

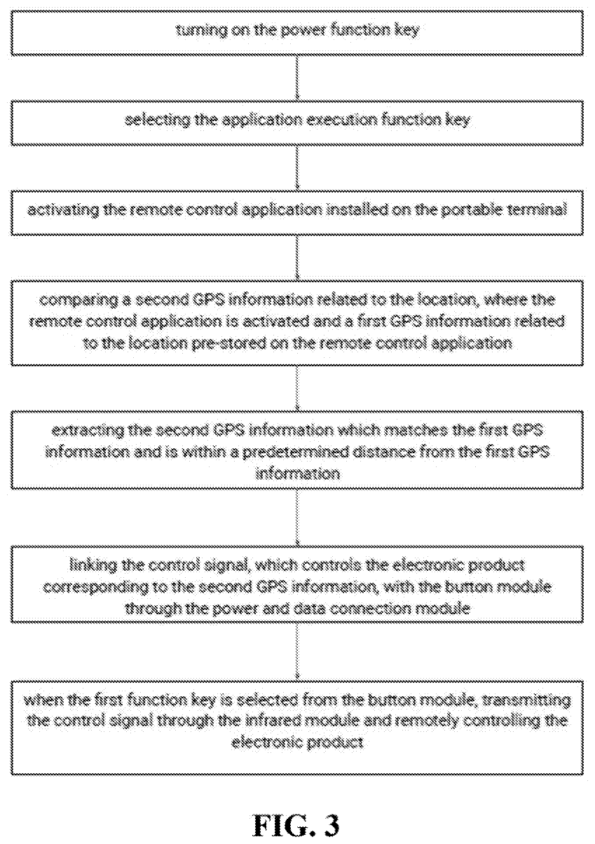

FIG. 3 is a flowchart illustrating a control method of controlling electronic products using the back cover for the portable terminal having a remote control function according to the present invention.

[Operation Using a Remote Controller According to the Present Invention]

A user turns on the power function key of the back cover in a house. Then, the application execution function key is selected. Next, when the remote control application of the portable terminal is activated, GPS information of the location where the remote control application is activated is compared with GPS information pre-stored on the remote control application (GPS information of the electronic products pre-registered at home or at workplace).

Next, GPS information is extracted which matches the pre-stored GPS information and is within a predetermined distance from the location where the remote control application is activated. For example, assuming that the GPS information of a first electronic product which is registered at home is GPS1 and the GPS information of a second electronic product which is registered at a workplace is GPS2, what is detected within a predetermined distance from current GPS location would be GPS1. Therefore, the remote control application would work to control the electronics that are pre-registered at home.

Next, a control signal for controlling the electronic product corresponding to the extracted GPS information is linked with the button module of the back cover through the power supply and data connection module. Accordingly, when a user selects a function key on the button module, a signal is transmitted through the infrared module to remotely control the electronic product.

As described above, electronic products are controlled using the back cover according to the present invention. The back cover is for a portable terminal and has a remote control function. The electronic products located at different places are individually registered. When a user selects the power function key and activates the application execution function key at a given location, a signal for controlling electronic products located at the given location is transmitted from the control unit of the portable terminal. The transmitted signal is transmitted through the power and data connection module and through the infrared module to outside. Therefore, the electronic products can be remotely controlled by the portable terminal conveniently regardless of locations.

The present invention can solve the following problems mentioned in the conventional art. (1) The conventional art merely implements a conventional remote control function on a smartphone case without linking it with the smartphone. (2) The conventional device is a wallet-type smartphone case. An infrared module that transmits an infrared ray to control an electronic product is connected to the case through a cable, making it inconvenient to use. It is also inconvenient in that the infrared module is required to be stored or carried in a holder provided on an inner connecting surface of the phone case. The inner connecting surface connects both sides of the phone case. (3) Various types of electronic products may be located at different places such as at home or at workplaces. It is difficult with a conventional device to individually remotely control such electronic products that are located in different places. However, it is possible to solve such problems using the present invention.

The description above is illustrative and the present invention is not limited thereto. It is apparent to a person having an ordinary skill in the art that various modifications and substitutions are possible without departing from the scope of the present invention. Therefore, the embodiments disclosed in the present invention and the accompanying drawings are illustrative. The present invention is not limited to these embodiments and accompanying drawings. The scope of protection of the present invention should be construed according to the following claims. The equivalents thereto should be construed within the scope of the present invention.

What is claimed is:

1. A back cover for a portable terminal having remote control function, comprising:
an infrared module provided on an upper end of the back cover, receiving power from the portable terminal, and emitting infrared rays;
a button module including function keys, provided on a front surface of the back cover, and transmitting a control signal to the infrared module, wherein the control signal remotely controls an electronic product;
a power supply and data connection module provided on a lower end of a back surface of the back cover;
an application execution function key provided on the back cover and executing a remote control application which is installed on the portable terminal; and
a camera activation function key provided on the back cover and activating a camera, wherein the camera is mounted on the portable terminal.

2. The back cover according to claim 1, further including:
a power function key,
wherein, when the power function key is turned on, the remote control application activates the remote control application,
wherein the remote control application receives GPS information from a position sensor of the portable terminal and controls through the button module the electronic product within a predetermined distance from the GPS information.

3. The back cover according to claim 1,
wherein, when the application execution function key is executed, a function control unit is displayed on a display unit of the portable terminal,
wherein the electronic product is controlled using the function control unit.

4. A method for controlling an electronic product using a back cover,
wherein the back cover is provided on a portable terminal and has a remote control function,
wherein the back cover comprises:
an infrared module provided on an upper end of the back cover, receiving power from the portable terminal, and emitting infrared rays;
a button module including function keys, provided on a front surface of the back cover, and transmitting a control signal to the infrared module, wherein the control signal remotely controls the electronic product;
a power supply and data connection module provided on a lower end of a back surface of the back cover;
an application execution function key executing a remote control application which is installed on the portable terminal;
a camera activation function key provided on the back cover and activating a camera, wherein the camera is mounted on the portable terminal; and
a power function key provided on a front surface of the back cover,
wherein the method comprises:
turning on the power function key;
selecting the application execution function key;
activating the remote control application installed on the portable terminal;
extracting a second GPS information which matches a first GPS information and is within a predetermined distance from the first GPS information, wherein the first GPS information is related to a first location where the remote control application is activated, wherein the second GPS information is related to a second location pre-stored on the remote control application;
linking the control signal with a first function key of the button module through the power and data connection module, wherein the control signal controls the electronic product corresponding to the second GPS information extracted; and
when the first function key is selected from the button module, transmitting the control signal through the infrared module and remotely controlling the electronic product.
